(19) United States
(12) Patent Application Publication
(10) Pub. No.: US 2009/0039218 A1
(43) Pub. Date: Feb. 12, 2009

(54) CARGO BOX SUPPORT DEVICE

(76) Inventor: Ethan Doyle, Kent, WA (US)

Correspondence Address: BLACK LOWE & GRAHAM, PLLC, 701 FIFTH AVENUE, SUITE 4800, SEATTLE, WA, 98104, US

(21) Appl. No.: 12/050,866

(22) Filed: Mar. 18, 2008

Related U.S. Application Data
(60) Provisional application No. 60/895,613, filed on Mar. 19, 2007.

(51) Int. Cl. F16M 13/02

(52) U.S. Cl. 248/200

(57) ABSTRACT

A cargo box support device according to the present invention includes a cargo box support bar sized and shaped to support a cargo box, and at least one attachment device for attaching the support bar to a wall, stud, or other structure. Embodiments of the support device include integral and discrete attachment devices. Other embodiments feature a support bar including a pair of approximately 90° bends in the bar, with the bar configured to support a box between the bends.

### CROSS REFERENCES TO RELATED APPLICATIONS

This application claims priority to and incorporates by reference in its entirety U.S. Provisional Patent Application No. 60/895,613 filed Mar. 19, 2007.

### FIELD OF THE INVENTION

An embodiment of the invention relates generally to support devices and methods, and more specifically, to a cargo box support device.

### BACKGROUND OF THE INVENTION

Cargo boxes for automobiles are well known. They are often removably mounted to the roof of a vehicle to provide extra storage space, with one or more receptacles formed in the box sized and shaped to receive one or more vehicle-mounted cargo storage racks. When not in use on a vehicle, however, they are bulky, cumbersome, and take up a lot of room in storage. What is needed is a convenient device and method to store a cargo box when not in use.

### SUMMARY OF THE INVENTION

A cargo box support device is described, including a cargo box support bar sized and shaped to support a cargo box, and at least one attachment device for attaching the support bar to a wall, stud, or other structure. Embodiments of the support device include integral and discrete attachment devices. Other embodiments feature a support bar including a pair of approximately 90° bends in the bar, with the bar configured to support a box between the bends.

### BRIEF DESCRIPTION OF THE DRAWINGS

The preferred and alternative embodiments of the present invention are described in detail below with reference to the following drawings:

FIG. 1 is a side perspective view of a device according to an embodiment of the present invention;

FIG. 2A depicts a side view of the support structure 14 united with another support structure 14 of the device depicted in FIG. 1;

FIG. 2B shows a cross-section along bisection line 2B of the vertical portion of support structure 14 depicted in FIG. 2A through the plane 2B-2B;

FIG. 2C depicts an alternate embodiment of a support section 14′;

FIG. 3A is a partial cutaway of the bracket 12 portion of the device 10 of FIG. 1;

FIGS. 3B-3E depicts top, perspective, front, and partial cross-sectional views of another embodiment of the bracket 12;

FIG. 4 depicts a cargo box being supported by the device of FIG. 1; and

FIG. 5 depicts the fasteners that attach the cargo box to the device of FIG. 1.

### DETAILED DESCRIPTION OF THE PARTICULAR EMBODIMENTS

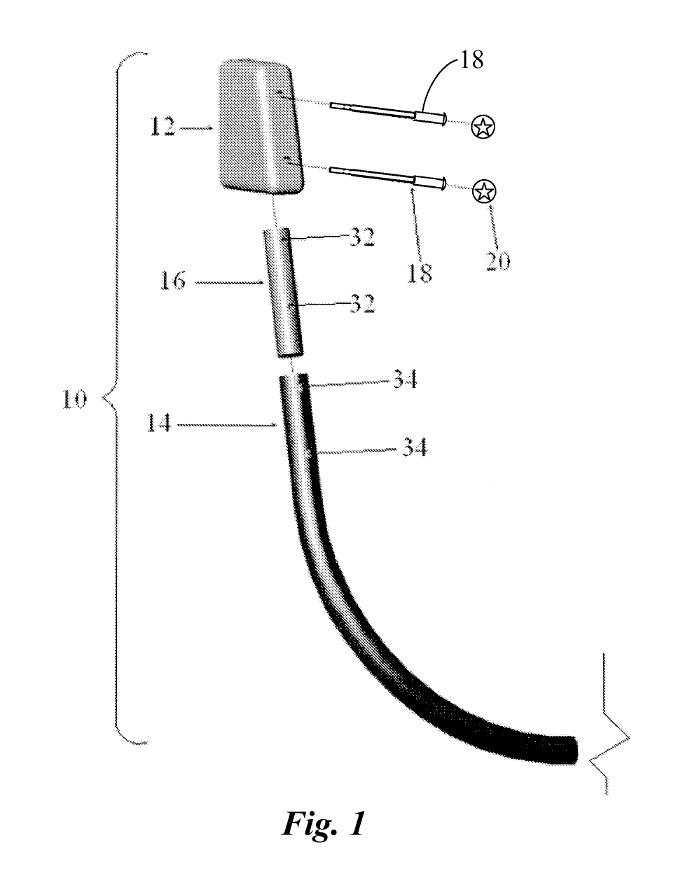

FIGS. 1-5 generally illustrate a cargo box support device that includes a cargo box support bar sized and shaped to support a cargo box, and at least one attachment device for attaching the support bar to a wall, stud, or other structure. Embodiments of the support device include integral and discrete attachment devices. Other embodiments feature a support bar including a pair of approximately 90° bends in the bar, with the bar configured to support a box between the bends.

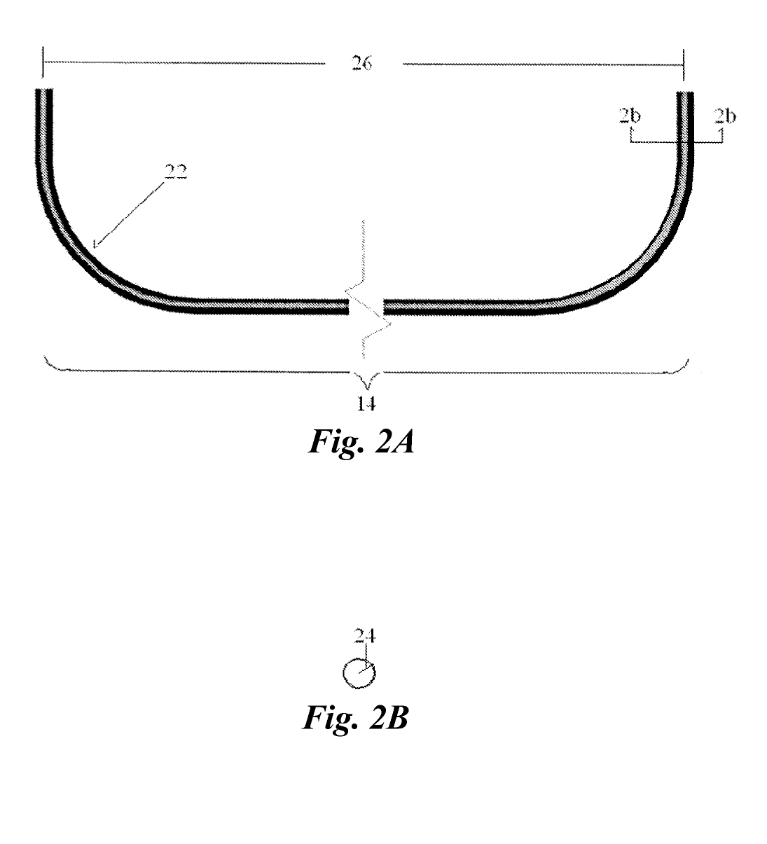

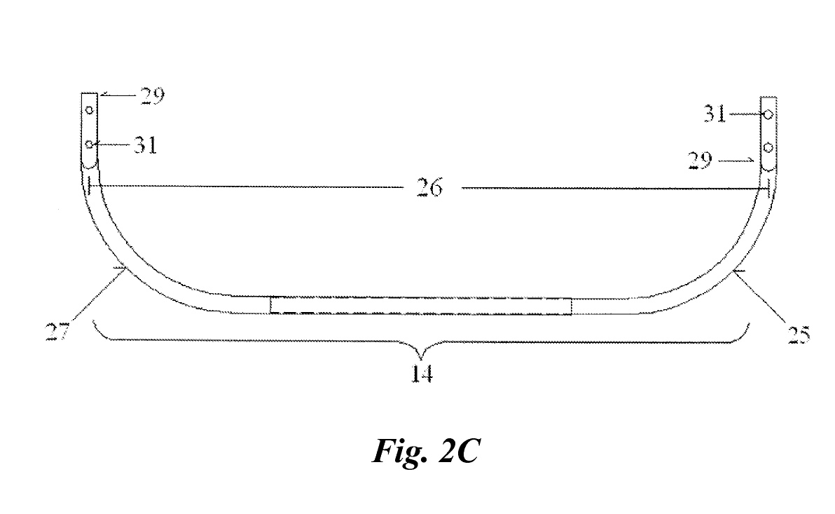

With reference to FIG. 1, which shows a portion of a device according to the current invention, and FIGS. 2A and 2B, which show a portion of the device of FIG. 1, the cargo box support device 10 includes two support brackets 12 and a support section 14. In an embodiment, the support section 14 is a tubular aluminum bar, but many configurations are possible. The embodiment shown includes two inserts 16 for connecting the support section 14 to the brackets 12, but in alternate embodiments, the support section 14 can be connected directly to the support brackets 12 without the inserts 16. The device 10 is affixed to any wall, ceiling stud (or pair of studs), or any other suitable support structure, by screws 18. The screws 18 secure the support section 14 and the inserts 16 to the support brackets 12 and a stud or other structure. Four decorative covers 20 can be used to conceal the screws 18.

In a preferred embodiment, the support section 14 has a radius of curvature of about six inches, a radius 24 of about 0.6875 inches, and a distance 26 of about 32 inches. The radius 24 is determined by the dimensions of a cargo box to be supported; alternatively, the radius can be small enough to support a cargo box with a small support section receptacle, and the device 10 will still operate to support cargo boxes with larger support section receptacles. The length 26 is determined by the width of a cargo box to be supported and the distance between studs (or support structures).

FIG. 2A depicts a side view of the support structure 14 united with another support structure 14 of the device depicted in FIG. 1. An approximate U-shaped configuration 26 terminus-to-terminus is presented. The distances for the terminus-to-terminus configuration 26 may be manufactured to pre-determined lengths. A curved region 22 transitions portions of the support structure 14 from a vertically disposed region to a horizontally disposed region. Cross-section line 2b is shown bisecting the vertical region of the support structure 14.

FIG. 2B shows a cross-section along bisection line 2B of the vertical portion of support structure 14 depicted in FIG. 2A through the plane 2B-2B. The plane 2B-2B of the support section 14 defines a radius 24.

FIG. 2C depicts an alternate embodiment of a support section 14′. The support section 14′ includes a male section 25 and a female section 27. The male section 25 may be slidably inserted into the female section to produce varying distances 26 terminus-to terminus. Additionally, the ends 29 may be flattened and include screw holes. Thus, the support section 14′ may be directly attached to a support structure without the need for brackets 12 or inserts 16.

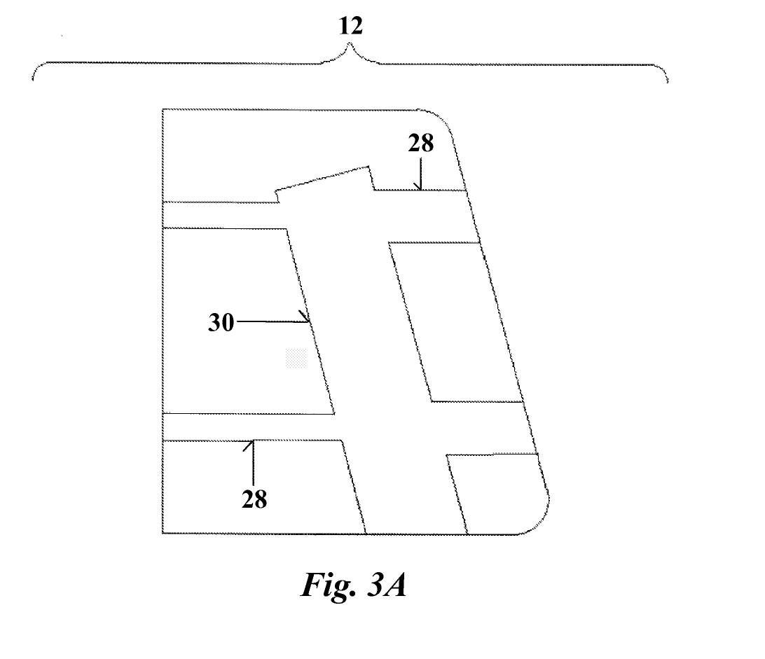

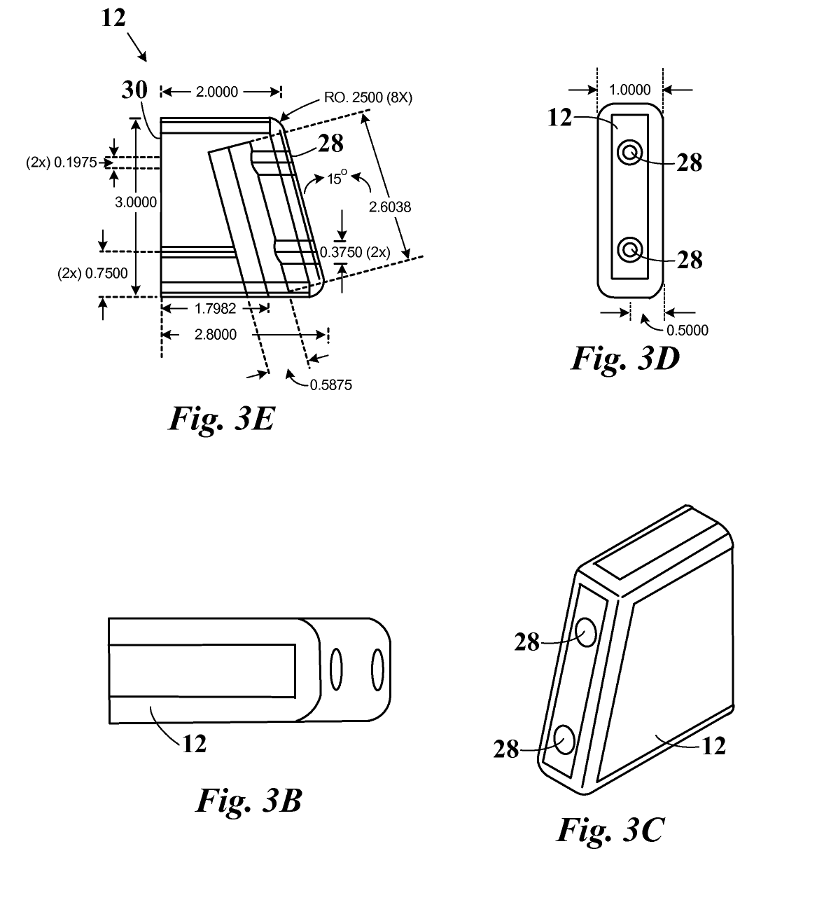

FIG. 3A is a partial cutaway view of the bracket 12 portion of the device 10 of FIG. 1. The bracket 12 includes a pair of screw receptacles 28 and a support section receptacle 30. In embodiments including the inserts 16, the receptacle 30 is sized and shaped to receive the insert 16 and support section 14, with insert holes 32 aligning with screw receptacles 28 such that screws 18 may be inserted through the support section 14 via support section holes 34, the insert 16, the bracket 12, and into a support structure. The inserts 16 can be many different lengths, depending on the preferred distance between the support section 14 and the brackets 12.

FIGS. 3B-3E depict top, perspective, front, and partial cross-sectional views of another particular embodiment of the bracket 12. FIG. 3B depicts a top view. FIG. 3C depicts a perspective view and FIG. 3D a front view showing the screw receptacles 28. An exemplary width of the bracket 12 may be approximately 1 inch as shown in the front view. FIG. 3E depicts another cross-sectional view showing the screw receptacles 28, which illustrate a front channel portion having a larger diameter that is bisected by the support section receptacle 30, and the rear channel portion of the screw receptacles 28 having a smaller diameter. FIG. 3E illustrates exemplary dimensions including a top dimension of approximately 2 inches, a rear side of approximately 3 inches, a bottom side of approximately 2.8 inches, and a slanted side face of approximately 2.5 inches. The distances between the screw hole receptacles 28 on the slanted face may be approximately 1.5 inches. The larger diameter of the screw hole receptacles 28 may be approximately 0.375 inches on the slanted face, and terminates on the rear side of approximately 0.1875 inches. The support section receptacle 30 is shown cut at an angle substantially parallel with the slanted face 30 and being approximately 1.8 inches on center from the rear side with an approximate diameter of 0.6875 inches. The angular cut of the support section receptacle 30 relative to the bottom side may be approximately 75 degrees. Other angular cuts are possible. In other alternate embodiments, the slanted face need not be substantially parallel with the support section receptacle 30, that is, the external appearance of the bracket 12 may present a block having substantially rectangular sides that are joined approximately 90 degrees relative to each other.

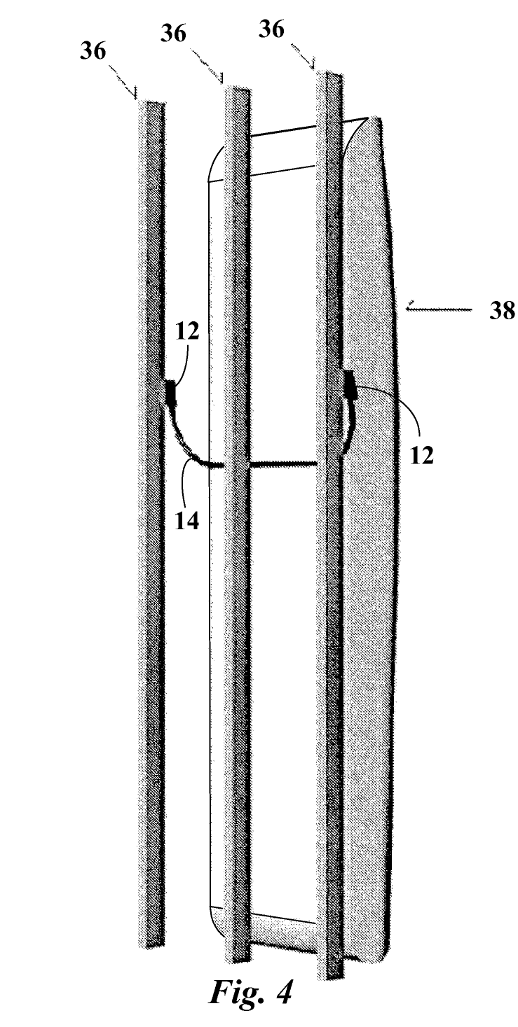

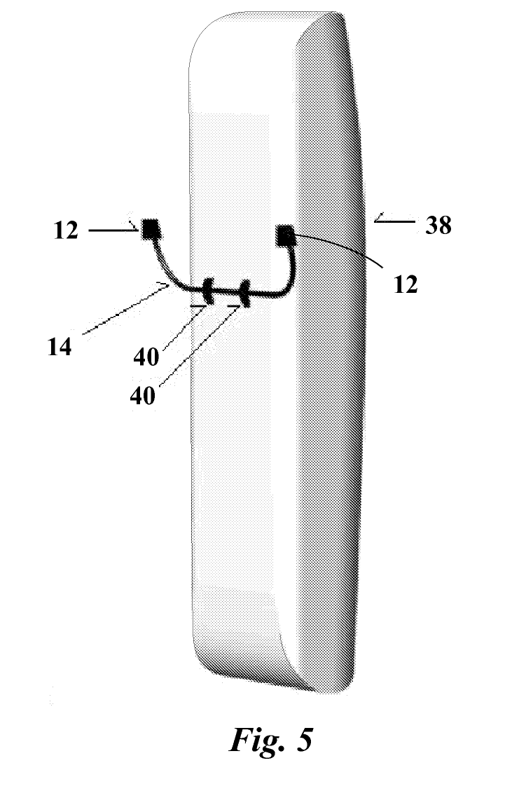

FIG. 4 depicts a side perspective view of a cargo box 38 being supported by the device 10 of FIG. 1. Brackets 12 are shown attached to rails or support structures 36. The support section 14 is attached with brackets 12 and may readily attach and detach to the cargo box 38 shown in FIG. 5 below.

FIG. 5 depicts the fasteners 40 that attach the cargo box 38 to the device 10 of FIG. 1. The fasteners 40 may comprise C-clamps, U-bolts, or quick release fittings that allow the ready attachment and detachment of the cargo box 38 to the support section 14 of the device 10.

While the preferred embodiment of the invention has been illustrated and described, as noted above, many changes can be made without departing from the spirit and scope of the invention. For example, more than one cargo box support device 10 may be used to secure the cargo box 38, and/or be placed in different orientations relative to the cargo box 38. Accordingly, the scope of the invention is not limited by the disclosure of the preferred embodiment. Instead, the invention should be determined entirely by reference to the claims that follow.

1. A device, comprising:
a support section sized and shaped to receive and support a cargo box;
a pair of attachment devices configured to attach the support section to a support structure.

2. The device of claim 1, wherein the support section comprises a rod having a pair of approximately 90° smooth curves, each curve adjacent to an end of the rod.

3. The device of claim 2, wherein a distance between ends of the rod is approximately one of 16 inches, 32 inches, and 48 inches.

4. The device of claim 3, wherein the rod is a tubular aluminum rod.

5. The device of claim 1, the attachment devices comprising brackets, each bracket including screw receptacles for attaching the bracket to a support structure and a support section receptacle for receiving an end of the support section.

6. The device of claim 1, further including a pair of inserts for attaching the brackets to the support section.

7. The device of claim 1, wherein the support section includes a male support section and a female support section, and the male support section can be slidably inserted into the female support section.

8. A device, comprising:
a support section including a male section and a female section, wherein one end of the male section is flattened and includes at least one screw hole, and the other end of the male section is sized and shaped to be slidably inserted into an end of the female section, and wherein one end of the female section is flattened and includes at least one screw hole, and the other end of the female section is sized and shaped to receive an end of the male section.
